(19) United States
(12) Patent Application Publication
(10) Pub. No.: US 2025/0380638 A1
(43) Pub. Date: Dec. 18, 2025

(54) LID TO COVER BATTERY HOUSING OF POWER EQUIPMENT

(71) Applicant: Honda Motor Co., Ltd., Tokyo (JP)

(72) Inventor: Christopher Todd Walker, Hillsborough, NC (US)

(21) Appl. No.: 18/746,695

(22) Filed: Jun. 18, 2024

(51) Int. Cl. A01D 34/81; A01D 101/00

(52) U.S. Cl. CPC A01D 34/81; A01D 2101/00

(57) ABSTRACT

A lid for covering a battery housing of a power equipment includes a cover arranged covering an opening of the battery housing. The lid also includes a latch pivotally coupled to the cover and adapted to pivot between a first position and a second position and biased to the first position. The latch has a hook adapted to be engaged with the battery housing to retain the cover in a closed position, covering the opening of the battery housing. The latch further has a push button adapted to be operated by a user to pivot the latch to the second position from the first position to disengage the cover from the battery housing.

### BACKGROUND

The disclosed subject matter relates to a lid for a power equipment. More particularly, the disclosed subject matter relates to a lid that selectively covers a battery housing of the power equipment.

Power equipment, such as lawnmowers, hedge trimmers, string trimmers, power saws, tillers, snow blowers, portable coolers, E-Bikes, and scooters may be operated by an electric motor, or a hybrid of an internal combustion engine and an electric motor. A battery mounted on the power equipment supplies power to the electric motor. The battery is removably mounted onto the power equipment, and is arranged inside a battery housing of the power equipment. Generally, a lid is attached to the battery housing to cover the battery housing, and the lid is opened, manually, to access the inside of the battery housing. However, existing lids may open, without user activation, during working, which is undesirable.

### SUMMARY

In accordance with one embodiment of the present disclosure, a lid for covering a battery housing of a power equipment is disclosed. The lid includes a cover adapted to be arranged covering an opening of the battery housing. The lid also includes a latch pivotally coupled to the cover and adapted to pivot between a first position and a second position and biased to the first position. The latch has a hook adapted to be engaged with the battery housing to retain the cover in a closed position, covering the opening of the battery housing. The latch further has a push button adapted to be operated by a user to pivot the latch to the second position from the first position to disengage the cover from the battery housing.

In accordance with another embodiment of the present disclosure, a power equipment is disclosed. The power equipment includes a battery housing and a cover pivotally coupled to the battery housing and adapted to be pivoted between an open position and a closed position. The cover is arranged covering an opening of the battery housing in the closed position. The power equipment further includes a latch pivotally coupled to the cover and adapted to pivot between a first position and a second position and biased to the first position. The latch comprises a hook adapted to be engaged with the battery housing in the first position of the latch to retain the cover in the closed position. The latch also includes a push button arranged to be operated by a user to pivot the latch to the second position from the first position to disengage the hook from the battery housing to move the cover to the open position.

In accordance with yet a further embodiment of the present disclosure a lawnmower is disclosed. The lawnmower includes a cutter housing having a blade chamber, and a plurality of wheels connected to and supporting the cutter housing. The lawnmower also includes a blade arranged, at least partially, in the blade chamber and rotatably mounted to the cutter housing to rotate about a blade axis. Moreover, the lawnmower includes a battery housing supported on the cutter housing, and a cover pivotally coupled to the battery housing and adapted to be pivoted between an open position and a closed position. The cover is arranged covering an opening of the battery housing in the closed position. Furthermore, the lawnmower includes a latch pivotally coupled to the cover and adapted to pivot between a first position and a second position and biased to the first position. The latch has a hook adapted to be engaged with the battery housing in the first position of the latch to retain the cover in a closed position. The latch also has a push button arranged to be operated by a user to pivot the latch to the second position from the first position to disengage the hook from the battery housing to move the cover to the open position.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a perspective view of a power equipment, in accordance with one embodiment of the present disclosure;

FIG. 2 illustrates a perspective schematic view of the power equipment of FIG. 1 with exterior portions of the power equipment shown in phantom and depicting various internal components of the power equipment, in accordance with one embodiment of the present disclosure;

FIG. 3 illustrates a sectional perspective view of a portion of the power equipment depicting a latch of a lid engaged with a battery housing, in accordance with one embodiment of the present disclosure;

FIG. 4 illustrates a top perspective view of a portion of the power equipment with a cover of the lid omitted and the latch engaged with the battery housing, in accordance with one embodiment of the present disclosure;

FIG. 5 is an exploded view of the lid disengaged from the battery housing, in accordance with one embodiment of the present disclosure;

FIG. 6 is an exploded view of the lid, in accordance with one embodiment of the present disclosure;

FIG. 7 is top perspective view of the latch with a pivot pin extending though the latch, in accordance with one embodiment of the present disclosure;

FIG. 8 is a side sectional view of a portion of the power equipment depicting the latch arranged at the first position with a hook engaged to a detent of the battery housing, in accordance with one embodiment of the present disclosure; and

FIG. 9 is a side sectional view of a portion of the power equipment depicting the latch arranged at the second position with the hook disengaged from the detent of the battery housing, in accordance with one embodiment of the present disclosure.

### DETAILED DESCRIPTION OF EXEMPLARY EMBODIMENTS

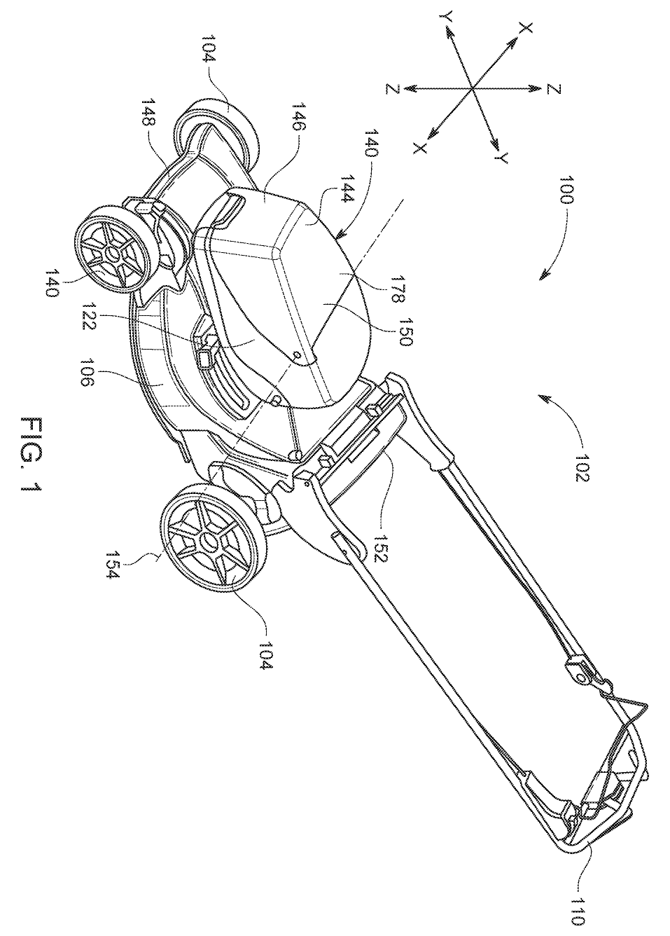

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-9, wherein like numbers indicate the same or corresponding elements throughout the views.

FIG. 1 illustrates a power equipment 100 according to an embodiment of the disclosure. In the illustrated embodiment, the power equipment 100 is a lawnmower 102, however, it may be appreciated that the power equipment 100 may be a tiller, a trimmer, snow blowers, portable coolers, e-bike, or any other similar equipment known in the art. The power equipment 100 may extend along an X-direction, a Y-direction and a Z-direction, with directions being orthogonal to each other. As shown, the power equipment 100 includes a plurality of traction members, for example, wheels 104 or tracks, to enable the movement of the power equipment 100 over a surface.

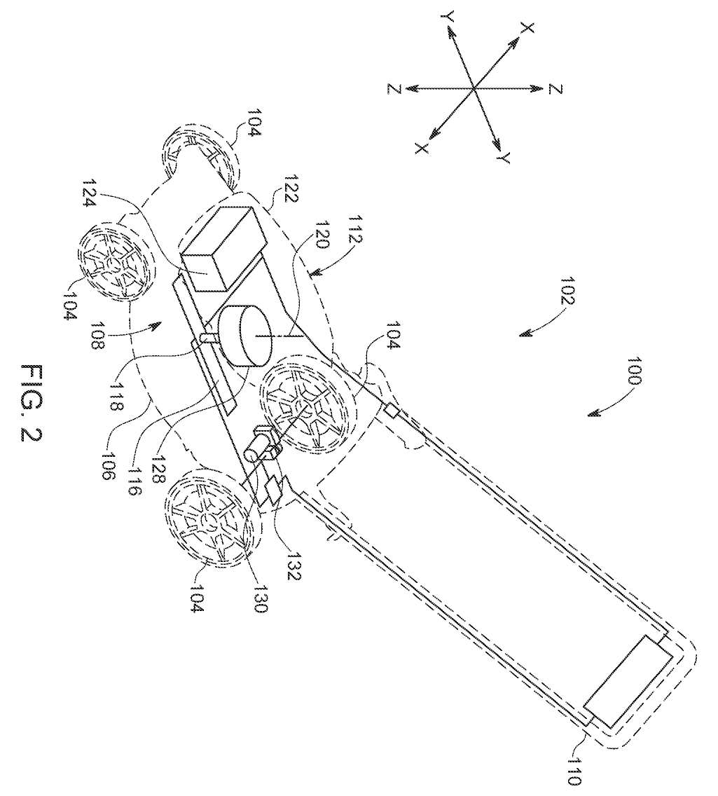

Referring to FIG. 2, the power equipment 100 includes a cutter housing 106 including a blade chamber 108 and supported on the wheels 104, a handle 110 to enable a holding of the power equipment 100 by a user, and a power source assembly 112. The cutter housing 106 may be referred to as a mower deck or as a cutter deck or as a deck. As shown, the power equipment 100 includes a blade 116 rotatably mounted to the cutter housing 106 and arranged at least partially inside the blade chamber 108 and a blade shaft 118 connecting the blade 116 and the power source assembly 112. The power source assembly 112 is configured to selectively rotate the blade shaft 118 and the blade 116 about a blade axis 120 which extends in the Z-direction. The power source assembly 112 includes a battery housing 122, a battery 124 removably arranged inside the battery housing 122, a blade motor 128 powered by the battery 124 to rotate the blade 116, a propulsion motor 130 powered by the battery 124, a transmission 132 operatively connecting the propulsion motor 130 to the rear wheels 104 to operate the wheels 104. In an embodiment, the transmission 132 may be omitted.

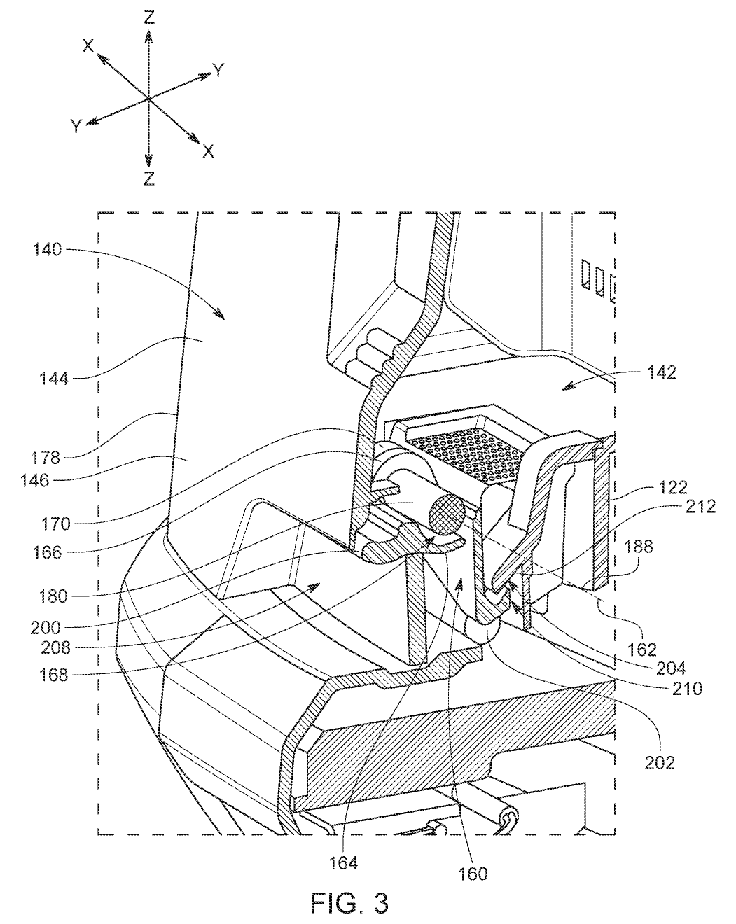

Also, the power equipment includes a lid 140 arranged covering an opening 142 (best shown in FIGS. 3 to 5) of the battery housing 122. As shown in FIG. 1, the lid 140 includes a cover 144 having a first end 146 arranged proximate to a front end 148 of the power equipment 100 and a second end 150 arranged proximate to a rear end 152 of the power equipment 100. As shown, the second end 150 of the cover 144 is pivotally coupled to the battery housing 122 and is configured to pivot about a pivot axis 154, for example, a first pivot axis 154, between a first position i.e., open position and a second position i.e., closed position. In the closed position, the cover 144 is arranged covering the opening 142 of the battery housing 122, while the in the open position, the cover 144 is arranged away from the opening 142, providing an access of an inside of the battery housing 122 through the opening 142. As shown, the pivot axis 154, extends in the X-direction, while the cover 144 extends in the Y-direction between the first end 146 and the second end 150.

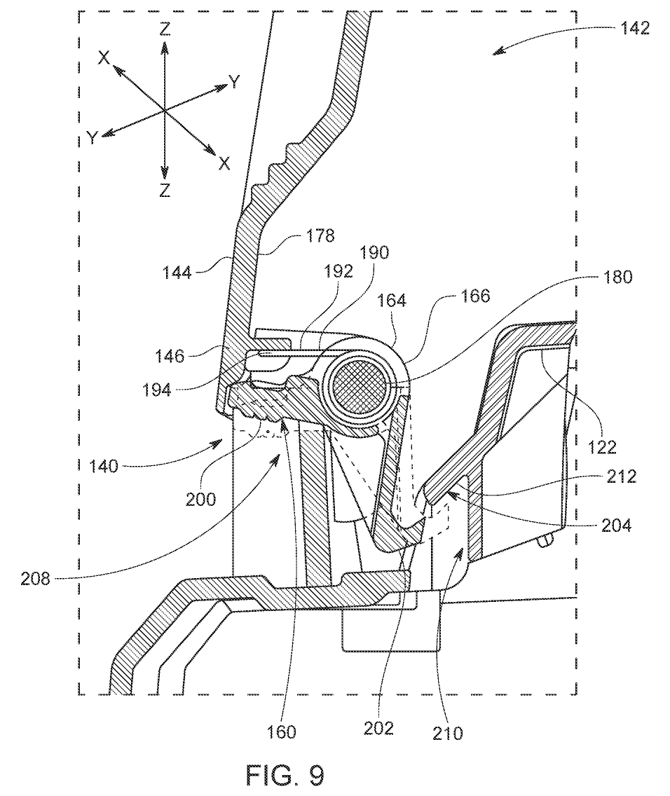

Further, referring to FIGS. 3 to 9, the lid 140 includes a latch 160 selectively coupling the cover 144 i.e., lid 140 with the battery housing 122. As shown, the latch 160 is arranged at the first end 146 of the cover 144 and is pivotally coupled to the cover 144. The latch 160 is arranged to pivot about a pivot axis 162, for example, a second pivot axis 162, that extends in substantially X-direction. The latch 160 is arranged to pivot between a first position i.e., engaged position (shown in FIGS. 3, 4, and 8) and a second position i.e., released position (shown in FIG. 9) about the second pivot axis 162. In the first position, the latch 160 is engaged with the battery housing 122 and retains the cover 144 in the closed position, while in the second position, as shown in FIG. 9, the latch 160 facilitates the pivoting/displacement of the cover 144 from the closed position to the open position.

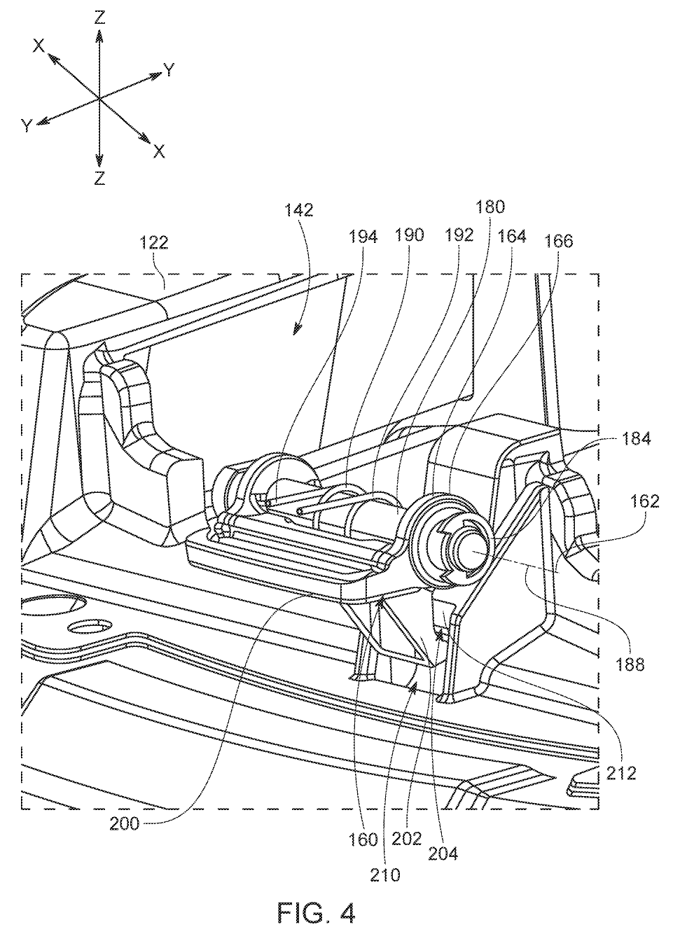

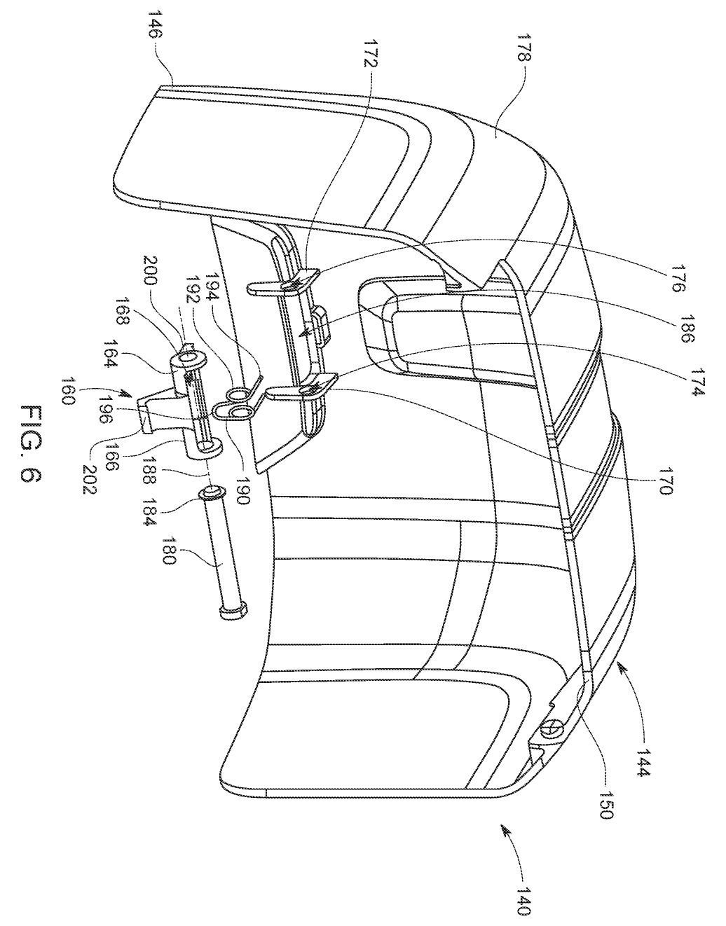

To pivotally couple the latch 160 with the cover 144, the latch 160 includes a central body 164 having an eye structure 166 defining an elongated channel 168 extending in the X-direction, and the cover 144 includes a pair of yokes 170, 172 defining a pair of holes 174, 176, as best shown in FIG. 6. The yokes extend in substantially Y-direction from a body 178 of the cover 144, while central axis of each of the holes 174, 176 extends in the X-direction. As shown, in the assembly of the latch 160 with the cover 144, the eye structure 166 is arranged/disposed between the pair of yokes 170, 172 with the holes 174, 176 aligned with the elongated channel 168. Moreover, the lid 140 includes a pivot pin 180 that extends through the holes 174, 176 and the elongated channel 176 and pivotally couple the latch 160 with the cover 144. To retain the pivot pin 180 in position and to prevent removal of the pivot pin 180 from the holes 174, 176 and/or the elongated channel 168, the lid 140 includes one or more circlips 184 (shown in FIGS. 4, 6, and 7). The one or more circlips 184 are mounted to the pivot pin 180 and are arranged at one or more ends of the pivot pin 180 and at a location outside of a gap 186 defined between the pair of yokes 170, 172. In the assembly, a central axis 188 of the pivot pin 180 and central axes of the holes 174, 176 align with the second pivot axis 162.

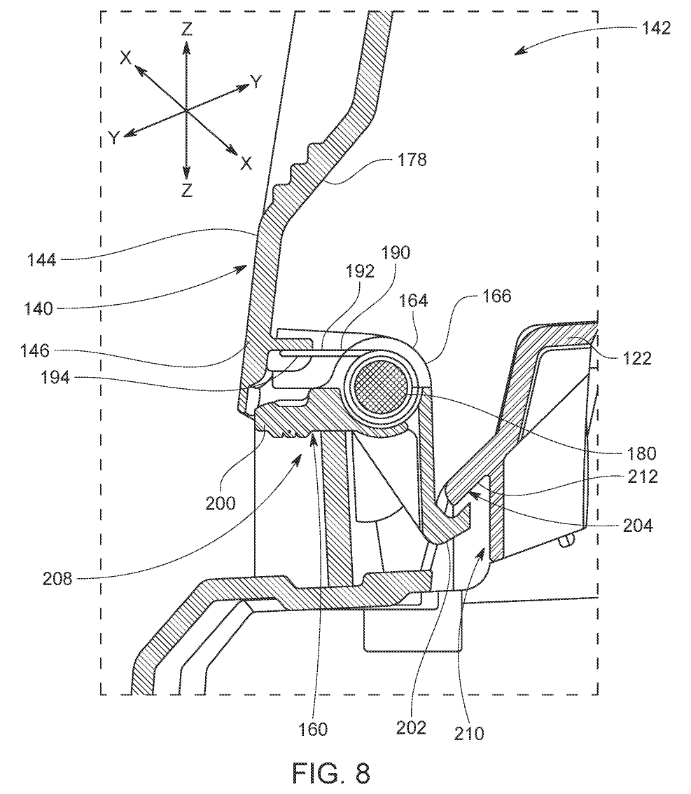

Additionally, the lid 140 includes a biasing member 190 engaged with the latch 160 and the cover 144, and biasing the latch 160 to the first position. As shown, the biasing member 190 is a spring 192 arranged around the pivot pin 180 and disposed inside the eye structure 166 and having a first end portion 194 engaged with the cover 144, shown in FIGS. 8 and 9, and a second end portion 196 engaged with the eye structure 166. Accordingly, the spring 192 provides a biasing force against the movement of the latch 160 from the first position and returns the latch 160 to the first position upon removal of a force applied by a user.

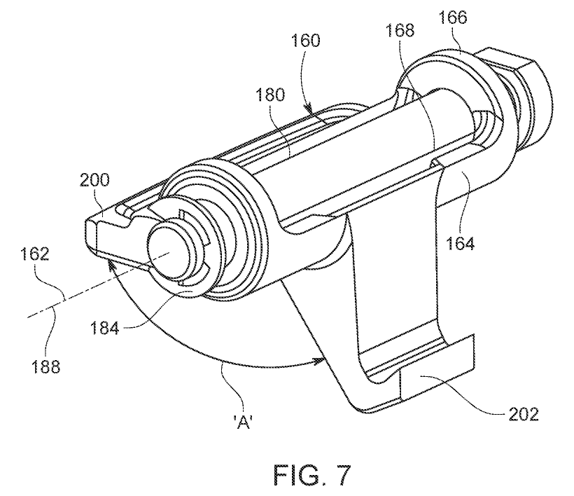

To facilitate an application of a force on the latch 160 and to move the latch from the first position to the second position and hence to disengage the latch 160 from the battery housing 122, the latch 160 includes a push button 200 extending on one side of the central body 164 in a Y-direction. Also, the latch 160 includes a hook 202 extending on other side of the central body 164 and in the Y-Z direction i.e., vertically downwardly from the central body 164. The hook 202 is adapted to engage with the battery housing 122 to facilitate a retention of the latch 160 with the battery housing 122 in the first position of the latch 160. As shown, the hook 202 extends obliquely from the central body 164 and defines an obtuse angle ‘A’ (shown in FIG. 7) with the push button 200. Accordingly, the push button 200 and the hook 202 are arranged on opposite sides of the eye structure 166 i.e., central body 164.

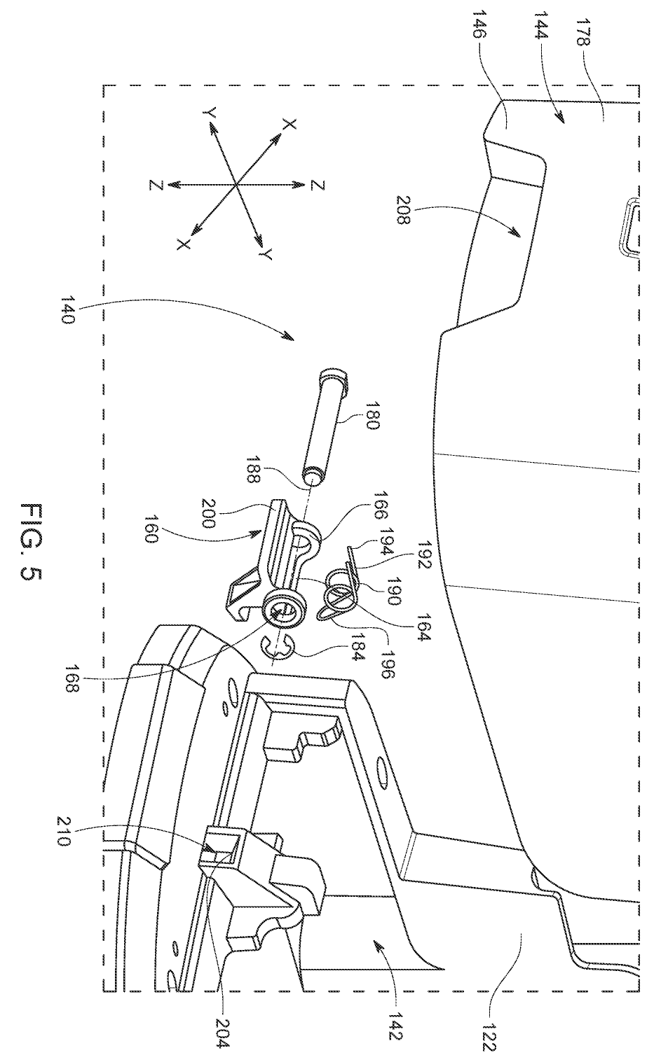

The hook 202 and the push button 200 are arranged such that a movement/displacement of the push button 200 in a first direction, for example, in the vertically upward direction, causes the hook 202 to rotate about the second pivot axis 162 in a first direction, causing the movement of the hook 202 away from the battery housing 122 and disengagement of the hook 202 from a detent 204 of the battery housing 122. As the push button 200 is released, the push button 200 moves downwardly due to the biasing force of the spring 192, rotating the hook 202 in the second direction opposite to the first direction about the second pivot axis 162. It may be appreciated that the hook 202 engages with the detent 204 as the cover 144 is moved to the closed position due to the closing force applied by the user on the lid. Also, the body 178 of the cover 144 may define a cut-out 208 (best shown in FIG. 5), and at least a portion of the push button 200 extends outwardly of the cover 144 inside the cut-out 208, in an assembly of the latch 160 with the cover 144. To move the latch 160 from the first position to the second position, and hence to move the cover 144 to the open position from the closed position, the user presses the push button 200, extending outwardly through the cut-out 208, vertically upwardly in the Z-direction.

A method of opening and closing the lid 140 is now described. To open the lid 140 and access the inside of the battery housing 122, a user may insert his/her hand inside the cut-out 208 of the cover 144 and pushes the push button 200 upwardly in the Z-direction, thereby moving/pivoting the latch 160 to the second position from the first position. In so doing, the hook 202 is disengaged from the detent 204 of the battery housing 122. Thereafter, the user holds the cover 144 and lifts the cover 144 to the open position by pivoting the cover 144 about the first pivot axis 154 relative to the battery housing 122. In this manner, the lid 140 is opened by first disengaging the latch 160 i.e., the hook 202 from the battery housing 122 i.e., detent 204 by displacing the latch 160 to the second position, and then lifting, manually, the cover 144 i.e., lid 140 by pivoting the cover 144 to the open position. It may be appreciated that the latch 160 moves back to the first position as soon as the user releases the push button 200 due to the biasing force of the spring 192. To close the lid 140 and hence to move the cover 144 to the closed position and engage the latch 160 with the detent 204 of the battery housing 122, the user pushes the cover 144 to the closed position by pressing the cover 144 downwardly. In response to pressing of the cover 144, the hook 202 is inserted inside a cavity 210 (best shown in FIG. 5) of the detent 204 and is engaged with a stopper 212 (best shown in FIGS. 3, 8, and 9) of the detent 204 to retain the cover 144 at the closed position. In this manner, the lid 140 enables an easy opening and an easy closing of the battery housing 122. Moreover, as opening of the cover 144 to the open position from the closed position is a two-step process, first pressing the push button 200 to disengage the latch 160 from the battery housing 122, and then lifting the cover 144 to the open position, any undesired opening of the lid 140 is prevented.

It should be noted that the lid as a whole may be oriented in any position. For example, the push button may move in a horizontal movement (instead of vertical direction) in order to de-latch the latch from the battery housing. Alternatively, the latch button could move diagonally. The mix of terms such as “horizontal” and “vertical” motion should not bind the present disclosure in one specific orientation – each of the button, cover, hook may move in various directions (including directions offset from vertical or horizontal directions) and still remain with the scope of the present disclosure.

In particular, the exemplary X-direction, Y-direction and Z-direction described above may represent a three-dimensional coordinate system for the lawnmower as an exemplary power equipment. However, alternate embodiments of the power equipment may be described by a three-dimensional XYZ coordinate system that is rotated relative to the XYZ coordinate system shown in FIG. 1. For example, instead of the Z-direction extending in a vertical direction and the X-direction and Y-direction extending in a horizontal direction as shown in FIG. 1, the XYZ coordinate system may be misaligned with respect to the vertical and horizontal directions.

Further, alternate embodiments of the lid may be described by a three-dimensional coordinate system that is independent of the three-dimensional coordinate system of the power equipment.

The lawnmower may be a walk-behind lawnmower, a ride-on lawnmower, a zero-turn-radius lawnmower, a remote-controlled lawnmower, an autonomous lawnmower, or a semi-autonomous lawnmower.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended the scope of the disclosure be defined by the claims appended hereto.

What is claimed is:

1. A lid for covering a battery housing of a power equipment, the lid comprising:
a cover adapted to be arranged covering an opening of the battery housing; and
a latch pivotally coupled to the cover and adapted to pivot between a first position and a second position and biased to the first position, the latch comprises
a hook adapted to be engaged with the battery housing to retain the cover in a closed position, covering the opening of the battery housing, and
a push button adapted to be operated by a user to pivot the latch to the second position from the first position to disengage the cover from the battery housing.

2. The lid of claim 1, wherein the lid includes a biasing member engaged to the latch to bias the latch to the first position.

3. The lid of claim 2, wherein the biasing member is a spring.

4. The lid of claim 1, wherein the cover includes a pair of yokes, and the latch includes an eye structure arranged between the pair of yokes and pivotally coupled to the pair of yokes.

5. The lid of claim 4 further comprises a pivot pin extending through the pair of yokes and the eye structure and pivotally coupling the latch to the cover, wherein a pivot axis of the latch aligns with a central axis of the pivot pin.

6. The lid of claim 4, wherein the hook and the push button extend on opposite sides of the eye structure.

7. The lid of claim 4, wherein the hook extends vertically and obliquely from the eye structure.

8. A power equipment, comprising:
a battery housing;
a cover pivotally coupled to the battery housing and adapted to be pivoted between an open position and a closed position, wherein the cover is arranged covering an opening of the battery housing in the closed position; and
a latch pivotally coupled to the cover and adapted to pivot between a first position and a second position and biased to the first position, the latch comprises
a hook adapted to be engaged with the battery housing in the first position of the latch to retain the cover in the closed position, and
a push button arranged to be operated by a user to pivot the latch to the second position from the first position to disengage the hook from the battery housing to move the cover to the open position.

9. The power equipment of claim 8, wherein the battery housing includes a detent adapted to be engaged with the hook in the first position of the latch to retain the cover in the closed position.

10. The power equipment of claim 8, wherein the lid includes a biasing member engaged to the latch to bias the latch to the first position.

11. The power equipment of claim 10, wherein the biasing member is a spring.

12. The power equipment of claim 8, wherein the cover includes a pair of yokes, the latch includes an eye structure arranged between the pair of yokes, wherein the power equipment further includes a pivot pin extending through the pair of yokes and the eye structure and pivotally coupling the latch to the cover.

13. The power equipment of claim 12, the hook extends vertically and obliquely from the eye structure.

14. A lawnmower, comprising:
a cutter housing including a blade chamber;
a plurality of wheels connected to and supporting the cutter housing;
a blade arranged, at least partially, in the blade chamber and rotatably mounted to the cutter housing to rotate about a blade axis;
a battery housing supported on the cutter housing;
a cover pivotally coupled to the battery housing and adapted to be pivoted between an open position and a closed position, wherein the cover is arranged covering an opening of the battery housing in the closed position; and
a latch pivotally coupled to the cover and adapted to pivot between a first position and a second position and biased to the first position, the latch comprises
a hook adapted to be engaged with the battery housing in the first position of the latch to retain the cover in a closed position, and
a push button arranged to be operated by a user to pivot the latch to the second position from the first position to disengage the hook from the battery housing to move the cover to the open position.

15. The lawnmower of claim 14, wherein the battery housing includes a detent adapted to be engaged with the hook in the first position of the latch to retain the cover in the closed position.

16. The lawnmower of claim 14, wherein the lid includes a biasing member engaged to the latch to bias the latch to the first position.

17. The lawnmower of claim 16, wherein the biasing member is a spring.

18. The lawnmower of claim 14, wherein the cover includes a pair of yokes, the latch includes an eye structure arranged between the pair of yokes, wherein lawnmower further includes a pivot pin extending through the pair of yokes and the eye structure and pivotally coupling the latch to the cover.

19. The lawnmower of claim 18, the hook extends vertically and obliquely from the eye structure.

20. The lawnmower of claim 14, wherein the cover is displaced to the open position by a user upon disengaging the hook from the detent by pressing the push button and moving the latch to the second position.
